(19) United States
(12) Patent Application Publication
(10) Pub. No.: US 2015/0127542 A1
(43) Pub. Date: May 7, 2015

(54) SYSTEM AND METHOD FOR VERBAL AUTHORIZATION FOR FULFILLMENT OF A SERVICE

(71) Applicant: Bank of America Corporation, Charlotte, NC (US)

(72) Inventors: Stephanie F. Seugling, Concord, NC (US); Robert Shannon Arroba, Charlotte, NC (US); Charles Cary Hudgins, Charleston, SC (US); Edward C. Ritter, Charlotte, NC (US); Selina Stanley Button, Antioch, CA (US); Keith A. Silvestri, Moreland Hills, OH (US); Suha Aburahma Freij, Charlotte, NC (US); Steven William Hoagland, Charlotte, NC (US); Scott Christopher Arcure, Chapel Hill, NC (US); Lisa A. Davis, Chatsworth, CA (US); Henry Jackson Thiel, III, Elkin, NC (US)

(21) Appl. No.: 14/592,285

(22) Filed: Jan. 8, 2015

Related U.S. Application Data
(63) Continuation of application No. 13/042,954, filed on Mar. 8, 2011.
(60) Provisional application No. 61/408,354, filed on Oct. 29, 2010.

(51) Int. Cl. G06Q 20/40

(52) U.S. Cl. CPC G06Q 20/40
USPC 705/44

(57) ABSTRACT

In some embodiments, a verbal authorization system comprises a financial services repository operable to store information identifying one or more financial services provided by a financial enterprise. The financial enterprise provides a financial service of the one or more financial services in response to a written authorization from a client. An eligibility engine is operable to determine whether the client is eligible to apply for verbal authorization status such that the client may provide verbal authorization during a telephone call to a fulfillment representative of the financial enterprise in lieu of the written authorization. A verbal authorization repository is operable to store client authorization information. The client authorization information identifies the client and whether the client has achieved the verbal authorization status.

### RELATED APPLICATIONS

This application is a continuation of U.S. application Ser. No. 13/042,954 entitled “SYSTEM AND METHOD FOR VERBAL AUTHORIZATION FOR FULFILLMENT OF A SERVICE,” filed Mar. 8, 2011. U.S. application Ser. No. 13/042,954 claims benefit under 35 U.S.C. §119(e) of U.S. Provisional Application Ser. No. 61/408,354, entitled “SYSTEM AND METHOD FOR VERBAL AUTHORIZATION FOR FULFILLMENT OF A SERVICE,” filed Oct. 29, 2010.

### TECHNICAL FIELD OF THE INVENTION

The present disclosure relates generally to transaction processing, and more particularly to a system and method for facilitating verbal authorization for fulfillment of a service.

### BACKGROUND

Clients may request one or more financial services from a financial enterprise. A financial service may include any product or service offered by the financial enterprise. Examples of financial services may include, but are not limited to, automated clearing house services, bookkeeping and account management services, direct deposit services, online checking services, lockbox services, account reconcilement product services, fraud detection services, wire transfer services, and electronic data interchange services.

### SUMMARY

In some embodiments, a verbal authorization system comprises a financial services repository operable to store information identifying one or more financial services provided by a financial enterprise. The financial enterprise provides a financial service of the one or more financial services in response to a written authorization from a client. An eligibility engine is operable to determine whether the client is eligible to apply for verbal authorization status such that the client may provide verbal authorization during a telephone call to a fulfillment representative of the financial enterprise in lieu of the written authorization. A verbal authorization repository is operable to store client authorization information. The client authorization information identifies the client and whether the client has achieved the verbal authorization status.

Certain embodiments may provide one or more technical advantages. A technical advantage of one embodiment may include the capability to facilitate a streamlined verbal authorization for acquisition of financial services that may be more efficient and less time-consuming than a traditional process for acquisition of a service. A technical advantage of one embodiment may also include the capability to have clients execute a single “master” agreement authorizing one or more of its entities to acquire services on behalf of the client via verbal authorization, thus eliminating the need for extensive written documentation. A technical advantage of one embodiment may also include the capability to provide security for a verbal authorization client entity via one or more challenge questions.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIGS. 1A and 1B show a verbal authorization system according to one embodiment;

FIG. 2 illustrates a method for requesting verbal authorization for fulfillment of a service, in accordance with particular embodiments of the present disclosure; and

FIG. 3 illustrates a method for facilitating verbal authorization for fulfillment of a service, in accordance with particular embodiments of the present disclosure.

### DETAILED DESCRIPTION OF THE INVENTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

A fulfillment representative is an employee of a financial enterprise who deals directly with clients (or, customers) of the financial enterprise. A financial enterprise may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A client may include one or more entities. For example, if the client is a company, the client may include several employees that are authorized to transact business with the financial enterprise. In another example, the client may be a company with several subsidiaries, each of which may be its own entity. In one example, a client may include both subsidiaries and employees as entities. Each subsidiary may also have subentities such as employees of the subsidiary. Teachings that apply to clients throughout this disclosure also apply to entities and subentities of the clients. As one example, teachings of certain embodiments recognize the capability to record and track information regarding clients as well as entities and subentities of the clients.

Clients may request one or more financial services from the financial enterprise. A financial service may include any product or service offered by the financial enterprise. Examples of financial services may include, but are not limited to, automated clearing house services, bookkeeping and account management services, direct deposit services, online checking services, lockbox services, account reconcilement product services, fraud detection services, wire transfer services, and electronic data interchange services.

Teachings of certain embodiments recognize the capability to facilitate a streamlined verbal authorization for acquisition of financial services that may be more efficient and less time-consuming than a traditional process for acquisition of a service. For example, a financial enterprise may require clients to sign numerous documents in connection with acquisition of a particular service. However, in one embodiment, clients may execute a single “master” agreement authorizing one or more of its entities to acquire services on behalf of the client via verbal authorization, thus eliminating the need for extensive written documentation. Teachings of certain embodiments also recognize the capability to provide security for a verbal authorization client entity via one or more challenge questions. In one embodiment, a fulfillment representative interacting with the client entity may not have access to the challenge answers, thereby ensuring client privacy.

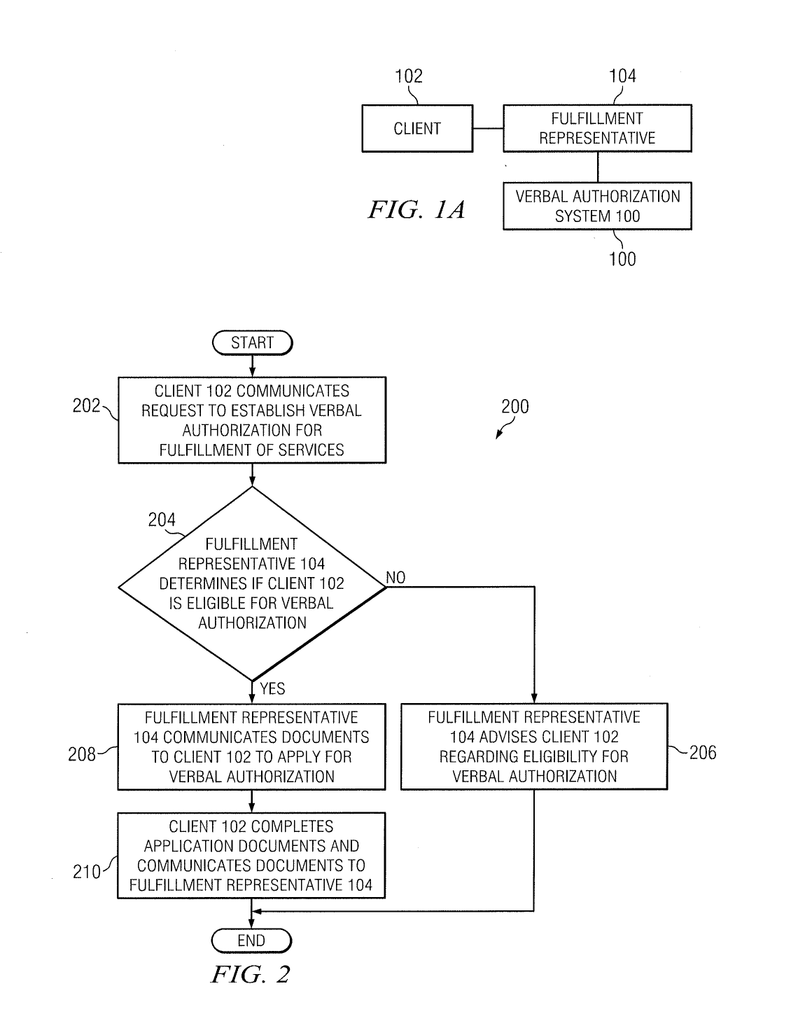

FIGS. 1A and 1B show a verbal authorization system 100 according to one embodiment. The example verbal authorization system 100 of FIG. 1B features financial services repository 110, eligibility engine 120, enrollment engine 130, verbal authorization repository 140, client authorization engine 150, audit repository 160, and client management interface 170, that may be implemented by one or more computer systems 10.

Users 5 may access verbal authorization system 100 through computer systems 10. Users 5 may include any individual, group of individuals, entity, machine, and/or mechanism that interacts with computer systems 10. Examples of users 5 include, but are not limited to, a teller, a manager, executive, review board, accountant, engineer, technician, contractor, agent, and/or employee. Users 5 may be associated with an organization. An organization may include any social arrangement that pursues collective goals. One example of an organization is a business. A business is an organization designed to provide goods or services, or both, to consumers, governmental entities, and/or other businesses. Examples of a business may include, but are not limited to, financial enterprises, agriculture and mining businesses, manufacturers, real estate companies, retailers and distributors, service businesses, transportation companies, and utility companies. A business may include both for-profit and not-for-profit businesses. An organization may also include multiple businesses. For example, an organization may control businesses in multiple jurisdictions throughout the world. Examples of organizations are not limited to businesses. For example, an organization can itself be a government entity.

In the example of FIG. 1A, user 5 may include fulfillment representative 104. Fulfillment representative 104 represents any person that may communicate with a client 102 to recommend to client 102 the purchase or acquisition of one or more services and/or any person who may manage or oversee the execution and completion of tasks required by an enterprise (e.g., a financial enterprise) to fulfill the services. In some embodiments, fulfillment representative 104 may also be a device such as a computing system. For example, in one embodiment, fulfillment representative 104 may be a device that communicates with client 102 electronically to recommend to client 102 the purchase or acquisition of one or more services and/or manages or oversees the execution and completion of tasks required by an enterprise (e.g., a financial enterprise) to fulfill the services.

In the example of FIG. 1A, client 102 communicates with verbal authorization system 100 through fulfillment representative 104. In some embodiments, however, client 102 may have direct access to all or a part of verbal authorization system 100. For example, in one embodiment, client 102 may access client management interface 170 to update or change information stored in verbal authorization repository 140.

Computer system 10 may include processors 12, input/output devices 14, communications links 16, and memory 18. In other embodiments, computer system 10 may include more, less, or other components. Computer system 10 may be operable to perform one or more operations of various embodiments. Although the embodiment shown provides one example of computer system 10 that may be used with other embodiments, such other embodiments may utilize computers other than computer system 10. Additionally, embodiments may also employ multiple computer systems 10 or other computers networked together in one or more public and/or private computer networks, such as one or more networks 30.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable data between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any data for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

Various communications between computers 10 or components of computers 10 may occur across a network, such as network 30. Network 30 may represent any number and combination of wireline and/or wireless networks suitable for data transmission. Network 30 may, for example, communicate internet protocol packets, frame relay frames, asynchronous transfer mode cells, and/or other suitable data between network addresses. Network 30 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although the illustrated embodiment shows one network 30, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

Financial services repository 110 represents a component that stores information identifying one or more financial services provided by a financial enterprise. The financial enterprise may provide these financial services to client 102 in response to a written authorization from client 102. In some scenarios, the financial enterprise may require a separate written authorization for each different financial service. Financial services repository 110 may identify financial services in any suitable manner. In one example, financial services repository 110 may store names or other identifiers of the financial services.

Eligibility engine 120 represents a component that determines whether client 102 is eligible to apply for a verbal authorization status. Verbal authorization status allows client 102 to provide verbal authorization during a telephone call to fulfillment representative 104 in lieu of written authorization. In some embodiments, fulfillment representative 104 may determine if client 102 is eligible to apply for verbal authorization based on information (e.g. one or more tasks) received from eligibility engine 120. For example, eligibility engine 120 may determine if client 102 is eligible based on one or business rules and/or requirements for eligibility and communicate information to fulfillment representative 104 regarding eligibility status. In other embodiments, fulfillment representative 104 may determine the eligibility status of client 102 without reference to verbal authorization system 100.

Enrollment engine 130 represents a component that facilitates an application by client 102 for verbal authorization status. For example, in one embodiment, enrollment engine 130 generates a verbal authorization status application for transmission to the client for the client's written signature. In the verbal authorization status application, client 102 may request verbal authorization status. In some embodiments, the verbal authorization status application may include an agreement to be executed by client 102 related to authorization of services via verbal authorization and/or documents upon which client 102 may provide authorization information (e.g., identity of entities of client 102 authorized for verbal authorization, passwords, personal identification numbers, answers to challenge questions, etc.). Documents may be communicated via traditional mail, electronic mail, or any other suitable electronic or non-electronic manner. Teachings of certain embodiments recognize that receiving one signature from client 102 on the verbal authorization status application may reduce or eliminate the need for signatures on multiple applications for financial services.

Enrollment engine 130 may also facilitate processing of returned verbal authorization status applications. A returned verbal authorization status application may represent a verbal authorization status application completed (in whole or in part) by client 102. In some embodiments, the returned verbal authorization status application may include information identifying client 102, a client authentication question for client 102, and an answer to the client authentication question. A client authentication question may include any question which fulfillment representative 104 may ask client 102 when client 102 verbally requests financial services. Examples of a client authentication question may include, but is not limited to, a request for personal identification information, a request for a password, and a challenge question.

Verbal authorization repository 140 may represent a component that stores client authorization information. Client authorization information may include information identifying client 102, such as the client's name, personal identification information, and/or a global client identifier used by the financial enterprise. Client authorization information may also include a client authorization question and an answer to the client authentication question provided by client 102. Client authorization information may also include information identifying whether client 102 has achieved verbal authorization status. In some embodiments, verbal authorization repository 140 may include a database tracking the verbal authorization condition of every client 102. For example, in one embodiment, client 102 may be classified in one of the following four conditions: (1) approved, (2) rejected, (3) declined, and (4) undecided. The approved condition indicates that client 102 has achieved verbal authorization status. The rejected condition indicates that either client 102 did not qualify to apply for verbal authorization status or that the financial enterprise rejected the verbal authorization status application of client 102. The declined condition indicates that client 102 declined to apply for verbal authorization status when presented with the opportunity. The undecided condition indicates that the financial enterprise has not offered to let client 102 apply for verbal authorization status or that client 102 has not decided whether to apply.

As explained above, a client may include one or more entities. Accordingly, teachings of certain embodiments recognize that verbal authorization repository 140 may store client authorization information on an entity by entity bases. For example, client 102 may have multiple employees, and each employee may have a different client authorization question and answer. As another example, client 102 may have multiple subsidiaries, and each subsidiary may have its own verbal authorization condition. As yet another example, client 102 may have multiple subsidiaries, each subsidiary having multiple employees, and each employee may have its own client authorization information.

Client authorization engine 150 may represent a component that facilitates determining whether client 102 has achieved verbal authorization status. In one example embodiment, client authorization engine 150 consults verbal authorization repository 140 in response to a request from client 102 and/or fulfillment representative 104. As one example, client authorization engine 150 may determine whether client 102 has achieved verbal authorization status during a telephone call between client 102 and fulfillment representative 104.

In some embodiments, client authorization engine 150 may retrieve a client authentication question from verbal authorization repository 140 for presentation to client 102. Client authorization engine 150 may also compare the answer to the client authentication question stored in verbal authorization repository 140 with an answer provided by client 102 during a telephone call with fulfillment representative 104. For example, in one embodiment, client 102 may provide an answer verbally to fulfillment representative 104 during a telephone call, fulfillment representative 104 may submit the answer to client authorization engine 150, and client authorization engine 150 may determine whether the answer provided matches the answer stored in verbal authorization repository 140.

Audit repository 160 represents a component that stores information identifying whether client 102 successfully provided verbal authorization during a telephone call. In some embodiments, audit repository 160 may track failed attempts to provided verbal authorization, such as incorrect answers to client authentication questions. In some embodiments, audit repository 160 may also track what financial services were requested and/or successfully ordered during a telephone call. In some embodiments, audit repository 160 may also log any other information identifying client 102, such as client authorization information. In some embodiments, audit repository 160 may also log information identifying the telephone call, such as the time of the call and the participants on the call.

Client management interface 170 may include any component operable to facilitate interaction between user 5 and verbal authorization repository 140. For example, client management interface 170 may include graphical, textual, and auditory information that facilitates the exchange of information between verbal authorization repository 140 and user 5. In one example embodiment, client 102 and/or fulfillment representative 104 uses client management interface 170 to change client authorization information stored in verbal authorization repository 140. As one example, client management interface 170 may incorporate a graphical user interface (GUI), such as a web-based user interface, that client 102 may use to change client authorization information. For example, client 102 may use client management interface 170 to change an answer to a client authentication question.

Although verbal authorization system 100 shows a client management interface 170, additional interfaces are contemplated. As one example, client 102 and/or fulfillment representative 104 may access financial services repository 110, eligibility engine 120, enrollment engine 130, verbal authorization repository 140, client authorization engine 150, audit repository 160, and/or client management interface 170 through one or more interfaces.

In operation, according to one embodiment, client 102 and fulfillment representative 104 engage in a first telephone conversation. During the first telephone conversation, fulfillment representative 104 suggests that client 102 apply for verbal authorization status. Fulfillment representative 104 engages eligibility engine 120 to determine whether client 102 is eligible to apply for verbal authorization status. If so, enrollment engine 130 generates a verbal authorization status application for transmission to client 102. Client 102 completes and signs the verbal authorization status application and submits it to the financial enterprise for processing by the enrollment engine 130. Enrollment engine 130 updates verbal authorization repository 140 to indicate that client 102 has achieved verbal authorization status.

In operation, according to another embodiment, client 102 and fulfillment representative 104 engage in a second telephone conversation. During the second telephone conversation, client 102 provides verbal authorization for financial services to fulfillment representative 104. Fulfillment representative 104 engages client authorization engine 150 to determine whether client 102 has achieved verbal authorization status such that client 102 may provide verbal authorization during the telephone call in lieu of written authorization. If client 102 has achieved verbal authorization status, client authorization engine 150 may request that fulfillment representative 104 present a client authorization question to client 102 for security purposes. If client 102 correctly answers the client authorization question, fulfillment representative 104 may process the request for financial services from client 102. Audit repository 160 may store a log of the transaction.

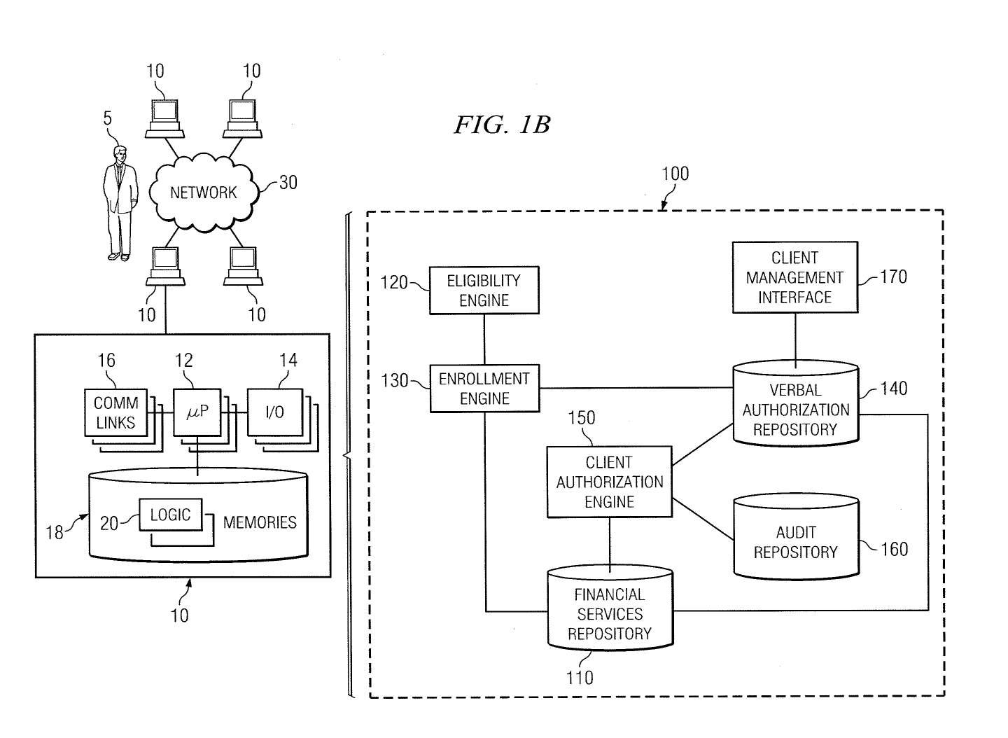

FIG. 2 illustrates a method 200 for requesting verbal authorization for fulfillment of a service, in accordance with particular embodiments of the present disclosure. Teachings of the present disclosure may be implemented in a variety of configurations of system 100. As such, the preferred initialization point for method 200 and the order of the steps 202-210 comprising method 200 may depend on the implementation chosen.

At step 202, client 102 may communicate a request to establish verbal authorization for fulfillment of services. In some embodiments, client 102 may communicate such request to fulfillment representative 104. In these and other embodiments, such request may be communicated via telephone, electronic mail, in-person, or via any other suitable form of electronic or non-electronic communication.

At step 204, fulfillment representative 104 may receive such request. For example, verbal authorization system 100 may communicate to fulfillment representative 104 a task or other message related to fulfillment of the request. Upon receiving the request, fulfillment representative 104 may determine if client 102 is eligible to apply for verbal authorization. In some embodiments, fulfillment representative 104 may determine if client 102 is eligible to apply for verbal authorization based on information (e.g., one or more tasks) received from verbal authorization system 100. For example, based on information stored on verbal authorization system 100 and/or one or business rules and/or requirements for eligibility, verbal authorization system 100 may determine if client 102 is eligible, and communicate information to fulfillment representative 104 regarding eligibility status. In other embodiments, fulfillment representative 104 may determine the eligibility status of client 102 without reference to verbal authorization system 100. If client 102 is eligible, method 200 may proceed to step 208. Otherwise, if client 102 is not eligible, method 200 may proceed to step 206.

At step 206, in response to a determination that client 102 is not eligible for verbal authorization, fulfillment representative 104 may advise client 102 regarding obtaining eligibility for verbal authorization. For example, verbal authorization system 100 may communicate information (e.g., tasks) to fulfillment representative 104 regarding items to be completed by client 102 in order to obtain eligibility, if possible. After completion of step 206, method 200 may end.

At step 208, in response to a determination that client 102 is eligible to apply for verbal authorization, fulfillment representative 104 may communicate documents to client 102 for client 102 to apply to verbal authorization. Such documents may include an agreement to be executed by client 102 related to authorization of services via verbal authorization and/or documents upon which client 102 may provide authorization information (e.g., identity of entities of client 102 authorized for verbal authorization, passwords, personal identification numbers, answers to challenge questions, etc.). Documents may be communicated via traditional mail, electronic mail, or any other suitable electronic or non-electronic manner.

At step 210, client 102 may complete the documents and communicate the documents to a fulfillment representative 104 (who may or may not be the same fulfillment representative 104 discussed in steps 202-208 above). The documents may be completed in any suitable manner (e.g., handwritten, typewritten into electronic form, etc.), including the execution of signatures by authorized users. After completion of step 210, verbal authorization may be established for client 102, and method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order. In addition, the steps comprising method 200 may be repeated, independently and/or collectively, as often as desired or required by a chosen implementation.

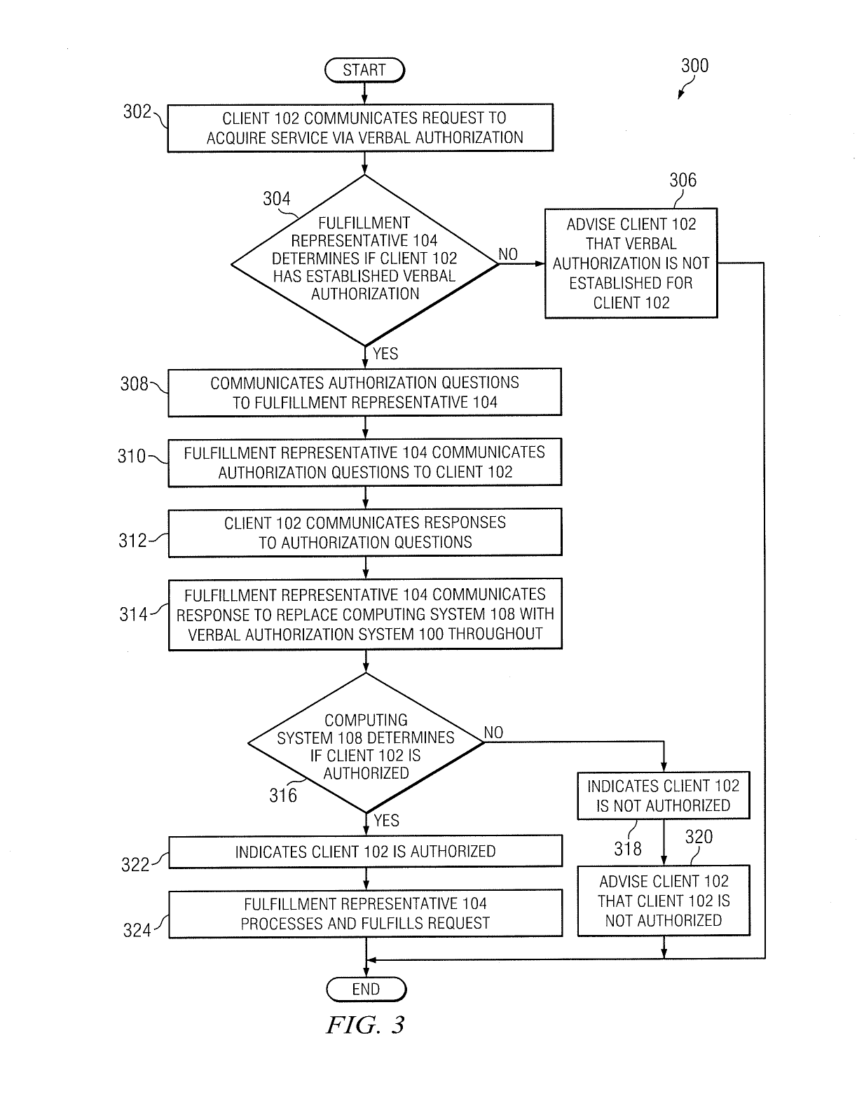

FIG. 3 illustrates a method 300 for facilitating verbal authorization for fulfillment of a service, in accordance with particular embodiments of the present disclosure. Method 300 may execute at some time after client 102 has completed the request for verbal authorization set forth in method 200. Teachings of the present disclosure may be implemented in a variety of configurations of system 100. As such, the preferred initialization point for method 300 and the order of the steps 302-324 comprising method 300 may depend on the implementation chosen.

At step 302, client 102 may communicate a request to acquire a service via verbal authorization. In some embodiments, client 102 may communicate such request to fulfillment representative 104. In these and other embodiments, such request may be communicated via telephone, electronic mail, in-person, or via any other suitable form of electronic or non-electronic communication.

At step 304, fulfillment representative 104 may determine if verbal authorization has been established for client 102 (e.g., pursuant to method 200). In some embodiments, fulfillment representative 104 may determine if client 102 has established verbal authorization based on information (e.g., one or more tasks) received from verbal authorization system 100. For example, based on information stored on verbal authorization system 100, verbal authorization system 100 may determine if client 102 has established verbal authorization, and communicate information to fulfillment representative 104 regarding whether verbal authorization is established. If client 102 has established verbal authorization, method 300 may proceed to step 308. Otherwise, if client 102 has not established verbal authorization, method 300 may proceed to step 306.

At step 306, in response to a determination that client 102 has not established verbal authorization, fulfillment representative 104 may advise client 102 that verbal authorization is not established for the client. In some embodiments, fulfillment representative 104 may assist client 102 in establishing verbal authorization (e.g., pursuant to method 200).

At step 308, in response to a determination that client 102 has established verbal authorization, verbal authorization system 100 may communicate authorization questions (e.g., as one or more tasks) related to client 102 (e.g., challenge questions, inquiry for a password, inquiry for a personal identification number, etc.).

At step 310, fulfillment representative 104 may communicate the authorization questions to client 102. At step 312, client 102 may communicate responses to the authorization questions to fulfillment representative 104. At step 314, fulfillment representative 104 may communicate the responses to verbal authorization system 100.

At step 316, verbal authorization system 100 may determine if client 102 is authorized. Such determination may be made based on the responses and/or information stored on verbal authorization system 100 (e.g., client-specific information provided in method 200 such as personal identification numbers, passwords, challenge questions and answers, etc.). If client 102 is authorized, method 300 may proceed to step 322. Otherwise, if client 102 is not authorized, method 300 may proceed to step 318.

At step 318, in response to a determination that client 102 is not authorized, verbal authorization system 100 may indicate to fulfillment representative 104 that client 102 is not authorized to make the request via verbal authorization. At step 320, fulfillment representative 104 may advise client 102 that client 102 is not authorized. After completion of step 320, method 300 may end.

At step 322, in response to a determination that client 102 is authorized, computing system 322 may indicate to fulfillment representative that client 102 is authorized to make the request via verbal authorization. Accordingly, at step 324, fulfillment representative 104 may process and fulfill the request.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order. In addition, the steps comprising method 300 may be repeated, independently and/or collectively, as often as desired or required by a chosen implementation.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A verbal authorization system, comprising:
a services repository operable to store information identifying one or more services, wherein the one or more services requires a client to provide written authorization;
an eligibility engine operable to:
determine whether the client is eligible to apply for verbal authorization status such that the client may provide verbal authorization in lieu of the written authorization during a first telephone call to a fulfillment representative;
generate a verbal authorization status application for transmission to the client for a written signature; and
process a returned verbal authorization status application to allow the client to provide verbal authorization during a second telephone call to the fulfillment representative in lieu of the written authorization;
a verbal authorization repository operable to store client authorization information, the client authorization information identifying the client and whether the client has achieved the verbal authorization status;
a client authorization engine operable to determine whether the client has achieved the verbal authorization status during the second telephone call; and
an audit repository operable to store information identifying whether the client successfully provided verbal authorization during the second telephone call.

2. The verbal authorization system of claim 1, wherein the verbal authorization repository is further operable to receive the returned verbal authorization status application from the client, the returned verbal authorization application comprising the information identifying the client.

3. The verbal authorization system of claim 1, wherein the client authorization information further comprises information identifying whether the client has opted not to apply for verbal authorization status.

4. The verbal authorization system of claim 1, wherein:
the client comprises a first entity and a second entity; and
the client authorization information identifies the first entity as having achieved the verbal authorization status and the second entity as not having achieved the verbal authorization status.

5. The verbal authorization system of claim 1, the client authorization information further comprising:
a client authentication question, and
an answer to the client authentication question provided by the client, wherein the answer is stored in the client authorization information.

6. The verbal authorization system of claim 5, wherein the client authorization engine is further operable to compare the answer stored in the client authorization information with an answer provided by the client during the second telephone call.

7. The verbal authorization system of claim 1, further comprising a client management interface operable to receive one or more changes to the client authorization information from the client.

8. A method, comprising:
storing information identifying one or more services, wherein the one or more services requires a client to provide written authorization;
determining, by a processor, whether the client is eligible to apply for verbal authorization status such that the client may provide verbal authorization in lieu of the written authorization during a first telephone call to a fulfillment representative;
generating a verbal authorization status application for transmission to the client for a written signature;
processing a returned verbal authorization status application to allow the client to provide verbal authorization during a second telephone call to the fulfillment representative in lieu of the written authorization;
storing client authorization information, the client authorization information identifying the client and whether the client has achieved the verbal authorization status;
determining, by the processor, whether the client has achieved the verbal authorization status during the second telephone call; and
storing information identifying whether the client successfully provided verbal authorization during the second telephone call.

9. The method of claim 8, further comprising receiving the returned verbal authorization status application from the client, the returned verbal authorization application comprising the information identifying the client.

10. The method of claim 8, wherein the client authorization information further comprises information identifying whether the client has opted not to apply for verbal authorization status.

11. The method of claim 8, wherein:
the client comprises a first entity and a second entity; and
the client authorization information identifies the first entity as having achieved the verbal authorization status and the second entity as not having achieved the verbal authorization status.

12. The method of claim 8, wherein the client authorization information further comprises:
a client authentication question, and
an answer to the client authentication question provided by the client, wherein the answer is stored in the client authorization information.

13. The method of claim 12, further comprising comparing the answer stored in the client authorization information with an answer provided by the client during the second telephone call.

14. The method of claim 8, further comprising receiving one or more changes to the client authorization information from the client.

15. A non-transitory computer readable medium comprising logic for execution, the logic, when executed by a processor, operable to:
store information identifying one or more services, wherein the one or more services requires a client to provide written authorization;
determine whether the client is eligible to apply for verbal authorization status such that the client may provide verbal authorization in lieu of the written authorization during a first telephone call to a fulfillment representative;
generate a verbal authorization status application for transmission to the client for a written signature;
process a returned verbal authorization status application to allow the client to provide verbal authorization during a second telephone call to the fulfillment representative in lieu of the written authorization;
store client authorization information, the client authorization information identifying the client and whether the client has achieved the verbal authorization status;
determine whether the client has achieved the verbal authorization status during the second telephone call; and
store information identifying whether the client successfully provided verbal authorization during the second telephone call.

16. The medium of claim 15, the logic, when executed, being further operable to receive the returned verbal authorization status application from the client, the returned verbal authorization application comprising the information identifying the client.

17. The medium of claim 15, wherein the client authorization information further comprises information identifying whether the client has opted not to apply for verbal authorization status.

18. The medium of claim 15, wherein:
the client comprises a first entity and a second entity; and
the client authorization information identifies the first entity as having achieved the verbal authorization status and the second entity as not having achieved the verbal authorization status.

19. The medium of claim 15, the client authorization information further comprising:
a client authentication question, and
an answer to the client authentication question provided by the client, wherein the answer is stored in the client authorization information.

20. The medium of claim 18, the logic, when executed, being further operable to compare the answer stored in the client authorization engine with an answer provided by the client during the second telephone call.
